(19) United States
(12) Patent Application Publication
(10) Pub. No.: US 2009/0014503 A1
(43) Pub. Date: Jan. 15, 2009

(54) Reflow apparatuses and methods for reflow

(75) Inventors: Jae-Hoon Choi, Cheonan-si (KR); Seong-Chan Han, Cheonan-si (KR); Se-Hyung Ryu, Cheonan-si (KR); Nam-Yong Oh, Cheonan-si (KR)

Correspondence Address: MILLS & ONELLO LLP, ELEVEN BEACON STREET, SUITE 605, BOSTON, MA, 02108, US

(73) Assignee: Samsung Electronics Co., Ltd., Suwon-si (KR)

(21) Appl. No.: 12/217,862

(22) Filed: Jul. 9, 2008

(30) Foreign Application Priority Data
Jul. 9, 2007 (KR) 10-2007-0068568

(51) Int. Cl. B23K 1/005; B23K 3/04; B23K 1/00

(52) U.S. Cl. 228/230; 228/19; 228/227

(57) ABSTRACT

There are provided reflow apparatuses and a methods therefor. In some embodiments, a reflow apparatus includes a first heating unit capable of heating a solder on a substrate up to just below before a melting point of the solder at ambient pressure such that the solder on the substrate is melted and electronic components mounted on the substrate are then soldered to the substrate; and a second heating unit connected to the first heating unit, the second heating unit capable of heating the solder on the substrate heated in the first heating unit through at least a portion of a solder melting temperature range in a vacuum state.

### CROSS-REFERENCE TO RELATED APPLICATION

This application claims priority to Korean Patent Application No. 2007-0068568, filed Jul. 9, 2007, the disclosure of which is hereby incorporated herein by reference in its entirety as if set forth fully herein.

### FIELD OF THE INVENTION

The present invention relates to reflow apparatuses and methods for reflow, for example, for soldering electronic components on a substrate.

### BACKGROUND

In general, a reflow apparatus refers to an apparatus for melting solder coated on a substrate and for soldering electronic components mounted on the substrate. In other words, in a reflow apparatus, a substrate mounted with electronic components is heated in a heating chamber while conveying the substrate with a conveyor or the like, thereby melting solder coated on the substrate. Then, the melted solder is cooled and solidified in a cooling chamber, thereby soldering the electronic components on the substrate. Exemplary reflow apparatuses have been disclosed in Korean Patent Laid-Open Publication Nos. 10-2004-0104737 (Title: Reflow Soldering Apparatus, published on Dec. 10, 2004) and 10-2002-0013712 (Title: Reflow Soldering Apparatus, published on Feb. 21, 2002), and the like.

According to the disclosed patents, a reflow apparatus heats solder coated on a substrate up to a solder melting temperature range using hot gas or wind produced by a heater, fan or the like, and then cools the solder, thereby performing soldering. That is, in the reflow apparatus, the solder coated on the substrate contacts hot air or wind by convection, which is one heat transfer method, thereby heating the solder up to the solder melting temperature range. Then, the melted solder is cooled and solidified, thereby performing the process of soldering the electronic components on the substrate.

However, when melting solder by means of hot air or wind using only convection and soldering electronic components through the melted solder, many problems may occur. For example, when melting solder by means of hot air wind using only convection and soldering electronic components through the melted solder, a portion of the solder, or a flux contained in the solder, may splash due to the convecting hot air or wind as illustrated in FIG. 1. In this case, a portion of the solder, a flux or the like can splash onto a tap terminal 14 or the like on a substrate 10, and thus corrosion, contamination or the like may be caused. Reference numeral 12 denotes a portion at which a portion of the solder, the flux or the like has splashed onto the tap terminal 14. In the reflow apparatus described above, the heating, melting and cooling of the solder are all performed at ambient pressure.

Therefore, when performing the reflow process on solder with the reflow apparatus, a void 18 may be produced in a solder joint 16 on a substrate 10 as illustrated in FIG. 2. In this case, the void 18 may cause an open failure of the solder joint 16.

### SUMMARY OF THE INVENTION

The present invention is directed to reflow apparatuses and methods, which can prevent a portion of a solder, a flux and the like from splashing in a reflow process. The reflow apparatuses and methods can also reduce voids from being produced in a solder joint in a reflow process.

In accordance with an exemplary embodiment, the present invention provides a reflow apparatus which includes a first heating unit capable of heating a solder on a substrate up to just below a melting point of the solder at ambient pressure such that the solder on the substrate is melted and electronic components mounted on the substrate are then soldered to the substrate; and a second heating unit connected to the first heating unit, the second heating unit capable of heating the solder on the substrate heated in the first heating unit through at least a portion of a solder melting temperature range in a vacuum state.

Further, the first heating unit may include a heater for heating an ambient gas in the first heating unit and a fan for sending the ambient gas heated by the heater toward the solder on the substrate, thereby heating the solder on the substrate by means of convection.

Further, the first heating unit may include a first substrate entry provided to allow the substrate coated with the solder to enter therethrough, a first substrate exit provided to allow the substrate entered through the first substrate entry to exit therethrough, and a first conveyor for conveying the substrate entered through the first substrate entry toward the first substrate exit.

Further, the second heating unit may include a heater for producing radiation heat, thereby heating the solder on the substrate by means of a non-contact method. The heater for heat radiation may include an infrared heater.

Further, the second heating unit may include a second substrate entry provided to allow the substrate passing through the first heating unit to enter therethrough, an entry shutter for opening/closing the second substrate entry, a second substrate exit provided to allow the substrate entered through the second substrate entry to exit therethrough, an exit shutter for opening/closing the second substrate exit, a second conveyor for conveying the substrate entered through the second substrate entry toward the second substrate exit, and a vacuum pump for changing and maintaining the second heating unit to be in a vacuum state.

Further, the reflow apparatus may further include a cooling unit connected to the second heating unit capable of cooling the solder on the substrate heated by the second heating unit. The cooling unit may include a third substrate entry provided to allow the substrate passing through the second heating unit to enter therethrough, a third substrate exit provided to allow the substrate entered through the third substrate entry to exit therethrough, a third conveyor for conveying the substrate entered through the third substrate entry toward the third substrate exit, a cooler for cooling an ambient gas in the cooling unit, and a cooling fan for sending the ambient gas cooled by the cooler toward the solder on the substrate.

In accordance with another exemplary embodiment, the present invention provides a reflow apparatus which includes a first heating unit including a heater for heating an ambient gas and a fan for sending the ambient gas heated by the heater, the first heating unit capable of heating a solder on a substrate up to just below a melting point of the solder by means of hot gas or wind using a convection method such that the solder on the substrate is melted and electronic components mounted on the substrate are then soldered to the substrate; and a second heating unit connected to the first heating unit and including a heater for producing radiation heat, the second heating unit capable of heating the solder on the substrate heated in the first heating unit through at least a portion of a solder melting temperature range by means of heat radiation using a non-contact method.

Further, the first heating unit may include a first substrate entry provided to allow the substrate coated with the solder to enter therethrough and a first substrate exit provided to allow the substrate entered through the first substrate entry to exit therethrough, the first heating unit capable of heating the solder on the substrate at ambient pressure.

Further, the second heating unit may include a second substrate entry provided to allow the substrate passing through the first heating unit to enter therethrough, an entry shutter for opening/closing the second substrate entry, a second substrate exit provided to allow the substrate entered through the second substrate entry to exit therethrough, an exit shutter for opening/closing the second substrate exit, and a vacuum pump for changing and maintaining the second heating unit to be in a vacuum state, the second heating unit capable of heating the solder on the substrate in a vacuum state.

In another aspect of the present invention, the present invention provides a reflow method for melting a solder on a substrate, thereby soldering electronic components mounted on the substrate. The reflow method includes first heating the solder on the substrate up to just below a melting point of the solder at ambient pressure using a first heating unit; and second heating the solder on the substrate heated in the first heating unit through at least a portion of a solder melting temperature range in a vacuum state using a second heating unit connected to the first heating unit and provided with a vacuum pump.

Further, in the first heating, the solder on the substrate may be heated with a heater provided to the first heating unit and a fan for sending an ambient gas heated by the heater toward the substrate by means of convection.

Further, in the second heating, the solder on the substrate may be heated with a heater provided to the second heating unit to produce radiation heat by means of heat radiation using a non-contact method.

Further, the reflow method may further include cooling the solder on the substrate heated in the second heating unit using a cooling unit connected to the second heating unit.

In accordance with another exemplary embodiment, the present invention provides a reflow method for melting a solder on a substrate, thereby soldering electronic components mounted on the substrate. The reflow method includes first heating the solder on the substrate up to just below a melting point of the solder with a first heating unit by means of convection, the first heating unit including a heater for heating an ambient gas and a fan capable of sending the ambient gas heated by the heater to the solder; and second heating the solder on the substrate through at least a portion of a solder melting temperature range with a second heating unit by heat radiation using a non-contact method, the second heating unit including a heater for heat radiation connected to the first heating unit to produce radiation heat.

Further, in the first heating, the solder on the substrate may be heated at ambient pressure.

Further, in the second heating, the solder on the substrate may be heated in a vacuum state using a vacuum pump provided to the second heating unit to change and maintain the second heating unit to be in the vacuum state.

### BRIEF DESCRIPTION OF THE DRAWINGS

The above and other features and advantages of the present invention will become more apparent to those of ordinary skill in the art by describing in detail embodiments thereof with reference to the attached drawings in which:

FIG. 1 is a photograph illustrating flux that has splashed onto a tap terminal on a conventional substrate;

FIG. 2 is a photograph illustrating a void produced in a solder joint on a conventional substrate;

FIG. 3 shows views illustrating a reflow apparatus according to an embodiment of the present invention, in which (A) is a view illustrating a configuration of the reflow apparatus, and (B) is a graph illustrating a temperature profile of the reflow apparatus;

FIG. 4 is a view illustrating a state in which a vacuum heating unit of the reflow apparatus in FIG. 3 is closed by shutters;

FIG. 5 is a graph illustrating a correlation between a vacuum degree and voids when performing a reflow process with the reflow apparatus according to the embodiment of the present invention;

FIG. 6 is a graph illustrating a correlation between conditions in a reflow process and the number of splashes of flux and the like as a function of the conditions;

FIG. 7 is a flowchart illustrating a reflow method according to an embodiment of the present invention; and

FIG. 8 is a flowchart illustrating a reflow method according to another embodiment of the present invention.

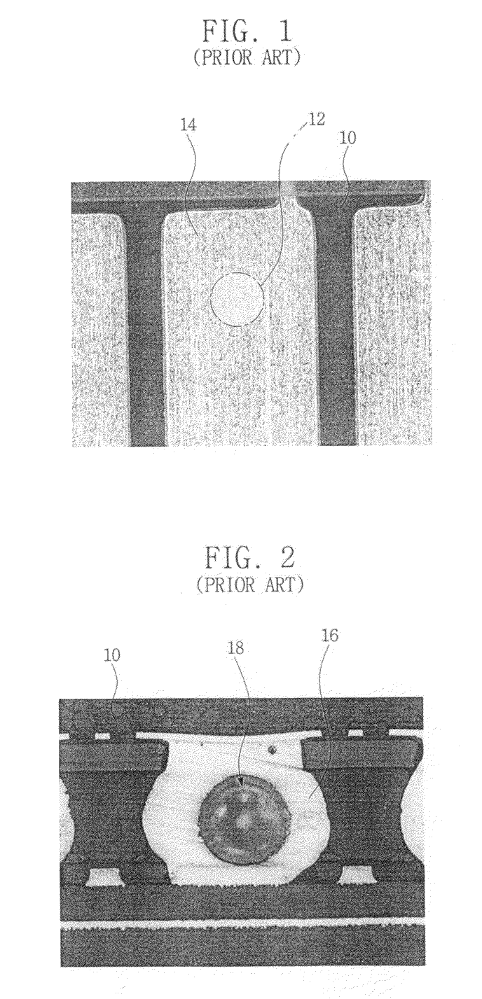

### DETAILED DESCRIPTION OF THE INVENTION

The present invention will now be described more fully hereinafter with reference to the accompanying drawings, in which embodiments of the invention are shown. This invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the thicknesses of layers and regions are exaggerated for clarity. Like numbers refer to like elements throughout the specification.

### An Embodiment of A Reflow Apparatus

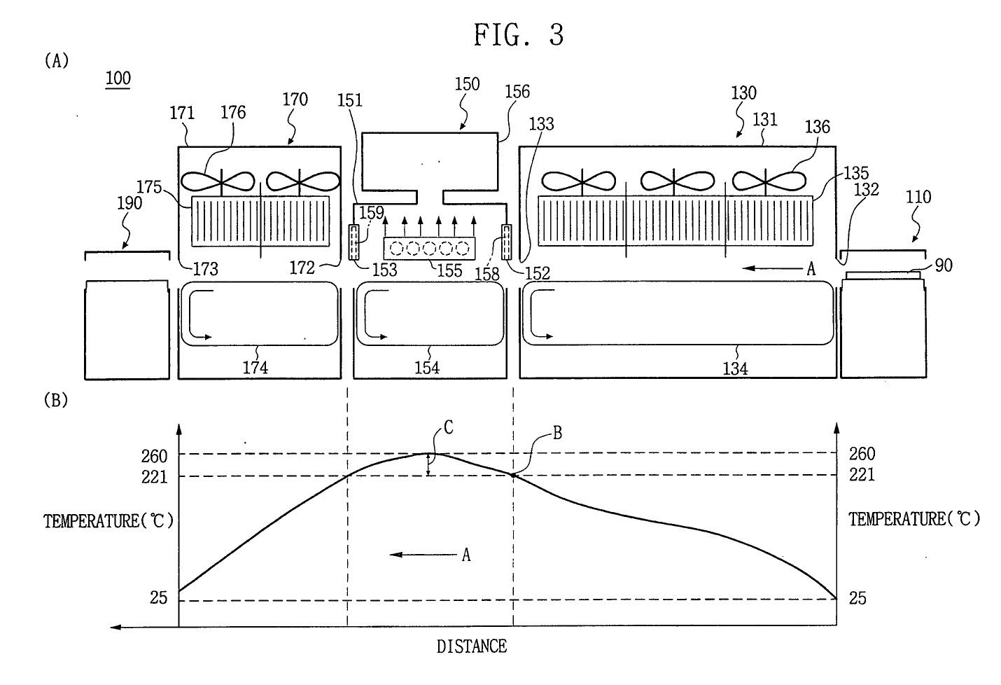

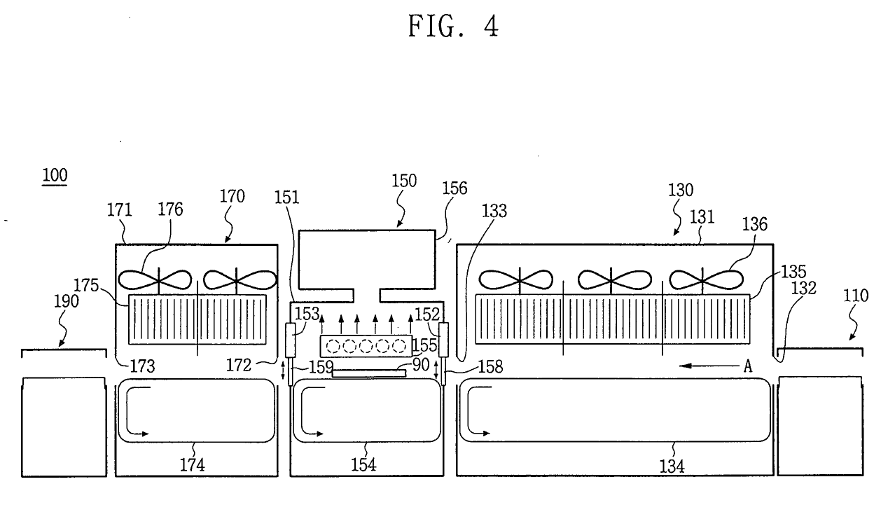

FIG. 3 shows views illustrating a reflow apparatus according to an embodiment of the present invention, in which (A) is a view illustrating the configuration of the reflow apparatus, and (B) is a graph illustrating temperature profile of the reflow apparatus. FIG. 4 is a view illustrating state in which a vacuum heating unit of the reflow apparatus in FIG. 3 is closed by shutters.

Referring to FIGS. 3 and 4, a reflow apparatus 100 according to the embodiment of the present invention includes a loader unit 110, a first heating unit 130, a second heating unit 150, a cooler 170 and an unloader unit 190. As shown, the loader unit 110, the first heating unit 130, the second heating unit 150, the cooling unit 170 and the unloader unit 190 are sequentially connected to be disposed in series. A substrate 90 to be soldered through a reflow process is conveyed from the loader unit 110 to the unloader unit 190, i.e., in direction A shown in FIG. 3.

The substrate 90 to be soldered through the reflow process, e.g., a substrate on which solder is coated and electronic components are then mounted, is loaded onto the loader unit 110. The substrate 90 loaded onto the loader unit 110 may be conveyed to the first heating unit 130 by an operator (not shown), a transfer robot (not shown), or the like.

The first heating unit 130 is connected to the loader unit 110. The first heating unit 130 preheats the solder on the substrate 90 supplied at room temperature such that the solder on the substrate 90 is melted, and the electronic components mounted on the substrate 90 is soldered to the substrate 90. That is, if the substrate 90 at room temperature, on which the solder is coated and the electronic components are then mounted, is conveyed from the loader unit 110, the first heating unit 130 heats the solder on the substrate 90 (which is at a normal pressure, i.e., atmospheric pressure), to just below the melting point B of the solder, which is a temperature at which the solder melts.

Specifically, the first heating unit 130 includes a body 131 formed in the shape of a chamber, a first substrate entry 132 provided at one side of the body 131 to allow the substrate 90 to enter from the loader unit 110 therethrough, a first substrate exit 133 provided at the other side of the body 131 to allow the substrate 90 entered through the first substrate entry 132 to exit therethrough, a first conveyor 134 disposed at an inner lower portion of the body 131 to convey the substrate 90 entered through the first substrate entry 132 toward the first substrate exit 133, a heater 135 for heating an ambient gas in the body 131, and a hot gas or wind fan 136 for sending the ambient gas heated by the heater 135 toward the solder on the substrate 90. The first heating unit 130 heats the solder on the substrate 90 by means of hot gas or wind using a convection method.

While the solder on the substrate 90 is heated, the first conveyor 134 can convey the substrate 90 entered through the first substrate entry 132 toward the first substrate exit 133 at a predetermined speed. That is, when the substrate 90 is conveyed toward the first substrate exit 133 by the first conveyor 134, the solder on the substrate 90 entered through the first substrate entry 132 can be heated up to just below the melting point B of the solder by means of the hot gas or wind.

Each of the heater 135 and the hot gas or wind fan 136 may be implemented in an appropriate number and disposed at an appropriate position such that the solder on the substrate 90 can be heated up to just below the melting point B of the solder while the first conveyor 134 conveys the substrate 90. For example, three heaters 135 and three hot gas or wind fans 136 may be implemented and disposed along the first conveyor 134 in series as illustrated in FIG. 3. Further, the heater 135 and the hot gas or wind fan 136 may be disposed at an upper portion of the path on which the substrate 90 is conveyed as illustrated in FIG. 3. However, the number and position of the heaters 135 and the hot wind gas or fans 136 may vary.

Nitrogen gas or air may be used as the ambient gas used in the body 131. The substrate 90 heated in the first heating unit 130 may be automatically conveyed to the second heating unit 150 by the first conveyor 134. Alternatively, the substrate 90 may be conveyed to the second heating unit 150 by an additional transfer robot (not shown).

The second heating unit 150 is connected to the first heating unit 130. The second heating unit 150 heats the solder on the substrate 90 heated in the first heating unit 130 through at least a portion of the solder melting temperature range C (e.g., the entire range), which includes the melting point B and higher temperatures, in a vacuum state. That is, the substrate 90 heated up to just below the melting point B of the solder is conveyed from the first heating unit 130, and the second heating unit 150 heats the solder on the substrate 90 through at least a portion of the solder melting temperature range C in a vacuum state that is lower than the atmosphere pressure such that the conveyed solder on the substrate 90 can be melted.

Specifically, the second heating unit 150 includes a body 151 formed in the shape of a chamber, a second substrate entry 152 provided at one side of the body 151 to allow the substrate 90 to enter from the first heating unit 130 therethrough, an entry shutter 158 for opening/closing the second substrate entry 152, a second substrate exit 153 provided of the other side of the body 151 to allow the substrate 90 entered through the second substrate entry 152 to exit therethrough, an exit shutter 159 for opening/closing the second substrate exit 153, a second conveyor 154 disposed at an inner lower portion of the body 151 to convey the substrate 90 entered through the second substrate entry 152 toward the second substrate exit 153, a vacuum pump 156 for changing and maintaining the interior of the body 151 to be in a vacuum state, and a heater 155 disposed in the body 151 to produce radiation heat for heating the solder on the substrate 90 using a radiation method. The second heating unit 150 heats the solder on the substrate 90 by means of heat radiation using a non-contact method in a vacuum state.

While the solder on the substrate 90 is heated, the second conveyor 154 can convey the substrate 90 entered through the second substrate entry 152 toward the second substrate exit 153 at a predetermined speed. That is, when the substrate 90 is conveyed toward the second substrate exit 153 by the second conveyor 154, the solder on the substrate 90 entered through the second substrate entry 152 can be heated up through the solder melting temperature range C by means of the radiation heat produced by the heater 155. The substrate 90 heated in the second heating unit 150 may be automatically conveyed to the cooling unit 170 by the second conveyor 154. Alternatively, the substrate 90 may be conveyed to the cooling unit 170 by an additional transfer robot (not shown).

When the substrate 90 passing through the first heating unit 130 enters through the second substrate entry 152, the vacuum pump 156 can be operated to change and maintain the interior of the body 151 of the second heating unit 150 to be in a vacuum state. For example, the entry shutter 158 and the exit shutter 159 respectively close the second substrate entry 152 and the second substrate exit 153. The degree of vacuum of the interior of the body 151 in the second heating unit 150 may vary as necessary or desired. For example, in order to enhance productivity, the degree of vacuum of the interior of the body 151 in the second heating unit 150 may be maintained at about ½ to about 1/10 of the normal pressure, i.e., about 500 to about 100 mbar. Alternatively, in order to obtain high quality substrates 90 with no voids, the degree of vacuum of the interior of the body 151 in the second heating unit 150 may be maintained at about 1/10 to about 1/10000 of the normal pressure, i.e., about 100 to about 0.1 mbar.

The heater 155 for heat radiation may be disposed at an upper portion in the body 155, e.g., above the path through which the substrate 90 is conveyed. The position of the heater 155 for heat radiation may vary. The heater 155 for heat radiation may be implemented as an infrared heater for radiating infrared rays with radiation heat. However, in addition to the infrared heater, various types of heaters capable of generating radiation heat may be used as the heater 155 for heat radiation. For example, a quartz heater, a ceramic heater, a halogen heater or the like may be used as the heater 155 for heat radiation.

The melting point B and the solder melting temperature range C (which includes melting point B and higher temperatures), i.e., the reflow temperature range, may vary depending on the composition of the solder coated on the substrate 90. For example, the melting point B and the solder melting temperature range C may vary as illustrated in Table 1 as follows. In Table 1, only representative compositions of SnPb-based solder and Pb-free solder are illustrated. In one embodiment of the present invention, a solder having the composition of Sn3.0Ag0.5Cu is used as an example of a Pb-free solder with a high melting point.

<Table 1>

Comparison of Melting Point and Solder Melting Temperature Range for each Solder

| | | Solder Melting | |
|---|---|---|---|
| | Melting | Temperature Range | |
| | Point | (° C.) (Reflow | |
| Composition (wt %) | (° C.) | Temperature Range) | Remark |
| Sn37Pb | 183 | 183~220 | Example of SnPb- |
| | | | based Solder |
| Sn3.0Ag0.5Cu | 221 | 221~260 | Example of Pb-free |
| | | | Solder with High |
| | | | Melting Point |
| Sn57Bi | 140 | 140~180 | Example of Pb-free |
| | | | Solder with Low |
| | | | Melting Point |

The cooling unit 170 is connected to the second heating unit 150. The cooling unit 170 functions to cool the solder on the substrate 90 that was heated in the second heating unit 150.

Specifically, the cooling unit 170 includes a body 171 formed in the shape of a chamber, a third substrate entry 172 provided at one side of the body 171 to allow the substrate 90 from the second heating unit 150 therethrough, a third substrate exit 173 provided at the other side of the body 171 to allow the substrate 90 entered through the third substrate entry 172 to exit therethrough, a third conveyor 174 disposed at an inner lower portion of the body 171 to convey the substrate 90 entered through the third substrate entry 172 toward the third substrate exit 173, a cooler 175 for cooling an ambient gas in the body 171, and a cooling fan 176 for sending the ambient gas cooled by the cooler 175 toward the solder on the substrate 90. The cooling unit 170 cools the solder on the substrate 90 by means of cool gas or wind using a convection method.

The unloader unit 190 is connected to the cooling unit 170. Hence, solder on the substrate 90 can be is melted, then cooled by the cooling unit 170 to solidify, and the substrate 90 on which the electronic components are soldered can be conveyed to the unloader unit 190. As shown, the substrate 90 cooled in the cooling unit 170 may be automatically conveyed to the unloader unit 190 by the third conveyor 174. Alternatively, the substrate 90 may be conveyed to the unloader unit 190 by an additional transfer robot (not shown).

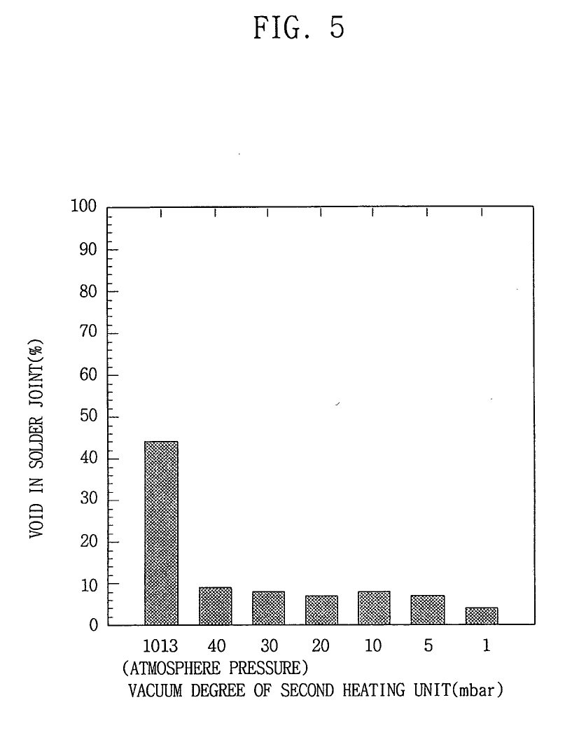

FIG. 5 is a graph illustrating a correlation between a degree of vacuum and voids when performing a reflow process with the reflow apparatus 100 according to the embodiment of the present invention. That is, FIG. 5 is a graph illustrating a correlation between a degree of vacuum and voids when performing a reflow process with the reflow apparatus 100 according to the embodiment of the present invention while sequentially changing the pressure of the second heating unit 150 in which the process is performed in a vacuum state from an atmosphere pressure of 1013 mbar to a high vacuum of 1 mbar. Referring to FIG. 5, when performing the reflow process while maintaining the pressure of the second heating unit 150 to be in a vacuum state with the reflow apparatus 100 according to the embodiment of the present invention, voids produced in a solder joint were remarkably reduced.

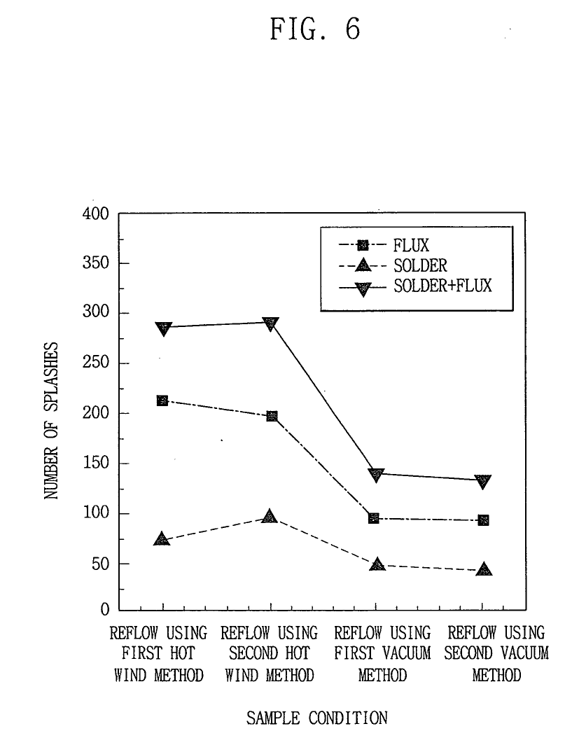

FIG. 6 is a graph illustrating a correlation between conditions in a reflow process and the number of splashes of flux and the like as a function of the conditions. In other words, FIG. 6 is a graph illustrating the number of splashes of flux and the like when performing the reflow process using hot gas or wind methods and the number of splashes of flux and the like when performing the reflow process using vacuum methods. Referring to FIG. 6, when performing the reflow process using the vacuum method according to the embodiment of the present invention, the number of splashes of solder, flux and the like was remarkably reduced.

### One Embodiment of Reflow Method

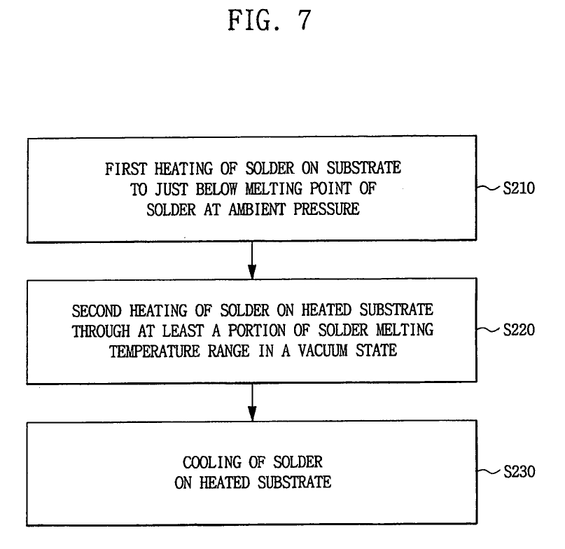

FIG. 7 is a flowchart illustrating a reflow method according to an embodiment of the present invention.

Referring to FIG. 7, the reflow method according to an embodiment of the present invention is a reflow method of melting solder on the substrate 90, thereby soldering electronic components mounted on the substrate 90. The reflow method includes a first heating operation (S210) of heating solder on the substrate 90 up to just below the melting point B of the solder at ambient pressure using the first heating unit 130, a second heating operation (S220) of heating the solder on the substrate 90 heated in the first heating unit 130 through at least a portion of the solder melting temperature range C, i.e., the reflow temperature range, in a vacuum state using the second heating unit 150 connected to the first heating unit 130 and provided with the vacuum pump 156, and a cooling operation (S230) of cooling the solder on the substrate 90 heated in the second heating unit 150 using the cooling unit 170 connected to the second heating unit 150.

The solder on the substrate 90 conveyed from the outside of the reflow apparatus 100, e.g., by the loader unit 110, is melted while passing through the first heating operation (S210) and the second heating operation (S220). Then, the solder on the substrate 90 is cooled and solidified while passing through the cooling operation (S230). Hence, the electronic components mounted on the substrate 90 are soldered onto the substrate 90 in the process of melting and then solidifying the solder.

In the reflow method according to the embodiment of the present invention, since the process of heating through at least a portion of the solder melting temperature range is performed in the second heating unit 150 in a vacuum state, voids produced in the solder joint are remarkably reduced in the process of performing the reflow process. As a result, a problem caused by producing voids in the solder joint, e.g., a problem of an open failure of the solder joint, can be minimized or prevented.

In the first heating operation (S210), the solder on the substrate 90 can be heated with the heater 135 provided in the first heating unit 130 and the hot gas or wind fan 136 for sending ambient gas heated by the heater 135 toward the substrate 90 by means of hot gas or wind using a convection method. In the second heating operation (S220), the solder on the substrate 90 can be heated with the heater 155 for heat radiation, provided in the second heating unit 150 to produce radiation heat by means of heat radiation using a non-contact method. Since the solder on the substrate 90 is heated with the heater 155 for heat radiation through at least a portion of the solder melting temperature range using a radiation method, the number of splashes of a portion of solder, a flux and the like in the process of performing the reflow process is remarkably reduced. As a result, a problem caused by a portion of the solder, the flux and the like splashing onto a tap terminal or the like on the substrate 90, e.g., corrosion, contamination or the like, can be minimized or prevented.

### Another Embodiment of Reflow Method

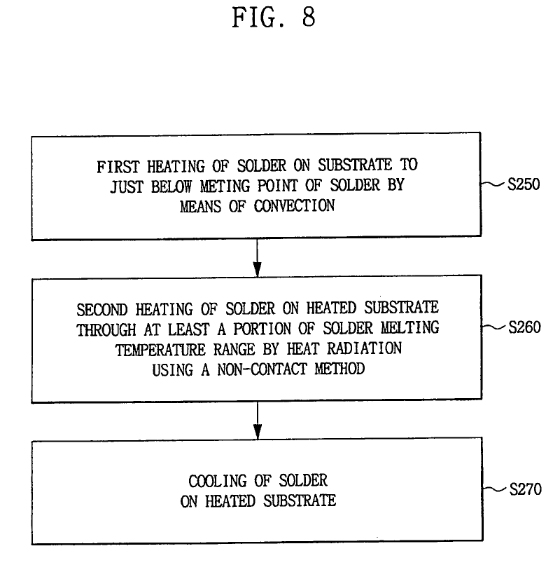

FIG. 8 is a flowchart illustrating a reflow method according to another embodiment of the present invention.

Referring to FIG. 8, the reflow method according to another embodiment of the present invention includes a first heating operation (S250) of heating a solder on the substrate 90 up to just below the melting point B of the solder with the first heating unit 130 including the heater 135 for heating an ambient gas and a hot gas or wind fan 136 for sending the ambient gas heated by the heater 135 by means of hot gas or wind using a convection method, a second heating operation (S260) of heating the solder on the substrate 90 heated in the first heating unit 130 through at least a portion of to the solder melting temperature range C with the second heating unit 150 including the heater 155 for heat radiation by means of heat radiation using a non-contact method, and a cooling operation (S270) of cooling the solder on the substrate 90 heated in the second heating unit 150 using the cooling unit 170 connected to the second heating unit 150.

The solder on the substrate 90 conveyed from the outside the reflow apparatus, e.g., the loader unit 110, is rapidly melted while passing through the first heating operation (S250) and the second heating operation (S260). Then, the solder on the substrate 90 is cooled and solidified while passing through the cooling operation (S270). Hence, the electronic components mounted on the substrate 90 are soldered onto the substrate 90 in the process of melting and then solidifying the solder.

In the reflow method according to the embodiment of the present invention, since the solder on the substrate 90 is heated through at least a portion of the solder melting temperature range with the heater 155 for heat radiation using a radiation method, the number of splashes of a portion of solder, a flux and the like is remarkably reduced in the process of performing the reflow process. As a result, a problem caused by a portion of the solder, the flux and the like splashing onto a tap terminal or the like on the substrate 90, e.g., corrosion, contamination or the like, can be minimized or prevented.

Further, in the reflow method according to the embodiment of the present invention, since the solder on the substrate 90 is heated by means of hot gas or wind using a hot gas or wind method in the first heating operation (S250) and by means of radiation heat using a heat radiation method in the second heating operation (S260), the solder on the substrate 90 can be more rapidly heated. Accordingly, the reflow process can be performed with productivity that is not more degraded than some conventional hot gas or wind methods.

Furthermore, in the reflow method according to the embodiment of the present invention, since the solder on the substrate 90 is heated by means of hot gas or wind using a convection method in the first heating operation (S250) and by means of radiation heat using a heat radiation method in the second heating operation (S260), uniform heat can be applied to all the solders coated on both sides of the substrate 90. Accordingly, the reflow method according to the embodiment of the present invention can be applied to apparatuses or modules, e.g., memory modules or the like, in which electronic components are mounted on both sides of a substrate.

In the first heating operation (S250), the solder on the substrate 90 can be heated in a normal pressure state. In the second heating operation (S260), the solder on the substrate 90 can be heated in a vacuum state using the vacuum pump 156 provided in the second heating unit 150 to change and maintain the second heating unit 150 to be in the vacuum state. Since the process of heating the solder on the substrate 90 through at least a portion of the solder melting temperature range is performed in the second heating unit 150, voids produced in the solder joint are remarkably reduced in the process of performing the reflow process. As a result, a problem caused by producing voids in the solder joint, e.g., a problem of an open failure of the solder joint, can be minimized or prevented.

As described above, in the reflow apparatuses and methods according to embodiments of the present invention, since solder on a substrate is heated through at least a portion of (e.g., entirely through) a solder melting temperature range using a heat radiation method, the number of splashes of a portion of the solder, a flux and the like is remarkably reduced in the process of performing a reflow process. Consequently, a problem caused by a portion of the solder, the flux and the like splashing onto a tap terminal or the like on the substrate, e.g., corrosion, contamination or the like, can be minimized or prevented.

Further, in the reflow apparatuses and methods according to embodiments of the present invention, since solder on a substrate is heated through at least a portion of (e.g., entirely through) a solder melting temperature range in a vacuum state, voids produced in a solder joint are remarkably reduced in the process of performing a reflow processing. Consequently, a problem caused by voids produced in the solder joint, e.g., an open failure of the solder of the solder joint can be minimized or prevented.

Furthermore, in the reflow apparatuses and methods according to embodiments of the present invention, since a solder on a substrate is heated by means of hot gas or wind using a hot gas or wind method in the first heating operation and by means of radiation heat using a heat radiation method in the second heating operation, the solder on the substrate can be more rapidly heated. Accordingly, the reflow process can be performed with productivity that is not more degraded than some other conventional hot gas or wind methods.

In addition, in the reflow apparatuses and methods according to embodiments of the present invention, since solder on a substrate is heated by means of hot gas or wind using a convection method in the first heating operation and by means of radiation heat using a heat radiation method in the second heating operation, uniform heat can be applied to all the solders coated on both sides of the substrate. Accordingly, the reflow methods according to embodiments of the present invention can be applied to devices or modules, e.g., memory modules or the like, in which electronic components are mounted on both sides of a substrate.

What is claimed is:

1. A reflow apparatus comprising:
a first heating unit capable of heating a solder on a substrate up to just below a melting point of the solder at ambient pressure such that the solder on the substrate is melted and electronic components mounted on the substrate are soldered on the substrate; and
a second heating unit connected to the first heating unit, the second heating unit capable of heating the solder on the substrate heated in the first heating unit through at least a portion of a solder melting temperature range in a vacuum state.

2. The reflow apparatus according to claim 1, wherein the first heating unit comprises a heater for heating an ambient gas in the first heating unit and a fan for sending the ambient gas heated by the heater toward the solder on the substrate, thereby heating the solder on the substrate by convection.

3. The reflow apparatus according to claim 1, wherein the first heating unit comprises a first substrate entry provided to allow the substrate coated with the solder to enter therethrough, a first substrate exit provided to allow the substrate entered through the first substrate entry to exit therethrough, and a first conveyor for conveying the substrate entered through the first substrate entry toward the first substrate exit.

4. The reflow apparatus according to claim 1, wherein the second heating unit comprises a heater for producing radiation heat, thereby heating the solder on the substrate by means of a non-contact method.

5. The reflow apparatus according to claim 4, wherein the heater for producing heat radiation comprises an infrared heater.

6. The reflow apparatus according to claim 1, wherein the second heating unit comprises a second substrate entry provided to allow the substrate passing through the first heating unit to enter therethrough, an entry shutter for opening/closing the second substrate entry, a second substrate exit provided to allow the substrate entered through the second substrate entry to exit therethrough, an exit shutter for opening/closing the second substrate exit, a second conveyor for conveying the substrate entered through the second substrate entry toward the second substrate exit, and a vacuum pump for changing and maintaining the second heating unit to be in a vacuum state.

7. The reflow apparatus according to claim 1, further comprising a cooling unit connected to the second heating unit capable of cooling the solder on the substrate heated by the second heating unit.

8. The reflow apparatus according to claim 7, wherein the cooling unit comprises a third substrate entry provided to allow the substrate passing through the second heating unit to enter therethrough, a third substrate exit provided to allow the substrate entered through the third substrate entry to exit therethrough, a third conveyor for conveying the substrate entered through the third substrate entry toward the third substrate exit, a cooler for cooling an ambient gas in the cooling unit, and a cooling fan for sending the ambient gas cooled by the cooler toward the solder on the substrate.

9. A reflow apparatus comprising:
a first heating unit including a heater for heating an ambient gas and a fan for sending the ambient gas heated by the heater, the first heating unit capable of heating a solder on a substrate up to just below a melting point of the solder by means of hot gas or wind using a convection method such that the solder on the substrate is melted and electronic components mounted on the substrate are then soldered to the substrate; and
a second heating unit connected to the first heating unit and including a heater for producing radiation heat, the second heating unit heating the solder on the substrate heated in the first heating unit through at least a portion of a solder melting temperature range by means of heat radiation using a non-contact method.

10. The reflow apparatus according to claim 9, wherein the first heating unit comprises a first substrate entry provided to allow the substrate coated with the solder to enter therethrough and a first substrate exit provided to allow the substrate entered through the first substrate entry to exit therethrough, the first heating unit capable of heating the solder on the substrate at ambient pressure.

11. The reflow apparatus according to claim 10, further comprising a first conveyer for conveying the substrate entered through the first substrate entry toward the first substrate exit.

12. The reflow apparatus according to claim 9, wherein the second heating unit comprises a second substrate entry provided to allow the substrate passing through the first heating unit to enter therethrough, an entry shutter for opening/closing the second substrate entry, a second substrate exit provided to allow the substrate entered through the second substrate entry to exit therethrough, an exit shutter for opening/closing the second substrate exit, and a vacuum pump for changing and maintaining the second heating unit to be in a vacuum state, the second heating unit capable of heating the solder on the substrate in a vacuum state.

13. The reflow apparatus according to claim 12, further comprising a second conveyer for conveying the substrate entered through the second substrate entry toward the second substrate exit.

14. The reflow apparatus according to claim 9, wherein the heater for producing heat radiation comprises an infrared heater.

15. The reflow apparatus according to claim 9, further comprising a cooling unit connected to the second heating unit, the cooling unit capable of cooling the solder on the substrate heated in the second heating unit.

16. The reflow apparatus according to claim 15, wherein the cooling unit comprises a third substrate entry provided to allow the substrate passing through the second heating unit to enter therethrough, a third substrate exit provided to allow the substrate entered through the third substrate entry to exit therethrough, a third conveyor for conveying the substrate entered through the third substrate entry toward the third substrate exit, a cooler for cooling an ambient gas in the cooling unit, and a cooling fan for sending the ambient gas cooled by the cooler toward the solder on the substrate.

17. A reflow method for melting a solder on a substrate, thereby soldering electronic components mounted on the substrate, comprising:
first heating the solder on the substrate up to just below a melting point of the solder at ambient pressure using a first heating unit; and
second heating the solder on the substrate heated in the first heating unit through at least a portion of a solder melting temperature range in a vacuum state using a second heating unit connected to the first heating unit and provided with a vacuum pump.

18. The reflow method according to claim 17, wherein, in the first heating, the solder on the substrate is heated with a heater provided to the first heating unit and a fan for sending an ambient gas heated by the heater toward the substrate by means of convection.

19. The reflow method according to claim 17, wherein, in the second heating, the solder on the substrate is heated with a heater provided in the second heating unit to produce radiation heat by means of a non-contact method.

20. The reflow method according to claim 17, further comprising cooling the solder on the substrate heated in the second heating unit using a cooling unit connected to the second heating unit.

21. A reflow method for melting a solder on a substrate, thereby soldering electronic components mounted on the substrate, comprising:
first heating the solder on the substrate up to just below a melting point of the solder with a first heating unit by means of convection, the first heating unit including a heater for heating an ambient gas and a fan capable of sending the ambient gas heated by the heater to the solder; and
second heating the solder on the substrate through at least a portion of a solder melting temperature range with a second heating unit by heat radiation using a non-contact method, the second heating unit including a heater for heat radiation connected to the first heating unit to produce radiation heat.

22. The reflow method according to claim 21, wherein, in the first heating, the solder on the substrate is heated at ambient pressure.

23. The reflow method according to claim 21, wherein, in the second heating, the solder on the substrate is heated in a vacuum state using a vacuum pump provided to the second heating unit to change and maintain the second heating unit to be in the vacuum state.

24. The reflow method according to claim 21, further comprising cooling the solder on the substrate heated in the second heating unit using a cooling unit connected to the second heating unit.
